(19) United States
(12) Patent Application Publication
(10) Pub. No.: US 2004/0207104 A1
(43) Pub. Date: Oct. 21, 2004

(54) Production method for lenticular lens sheet

(76) Inventors: Youji Ono, Niigata Pref (JP); Yoshio Abe, Niigata Pref (JP); Mitsunori Saitou, Niigata Pref (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,354

(22) PCT Filed: Aug. 26, 2002
(86) PCT No.: PCT/JP02/08561

(30) Foreign Application Priority Data
Aug. 27, 2001 (JP) 2001-255420

(51) Int. Cl. B29D 7/01

(52) U.S. Cl. 264/1.34

(57) ABSTRACT

It is an object of the present invention to provide a method for efficiently producing a lenticular lens providing an excellent contrast. The aforesaid object is achieved by a method for producing a lenticular lens sheet 2, comprising a step of, on a lenticular lens sheet substrate 10 having a lens group made up of lenticular lenses 11 arranged in parallel to one another on one side of the light transmissive substrate, and protrusions 4 each made up of a top and slopes at non-condensing portions of the lenticular lenses 11 on the other side, rotating a print roll 5 coated with an uncured light absorbing material 8, relatively moving the lenticular lens sheet substrate 10 with respect to the axis of the print roll while bringing the print roll 5 in contact with the tops of the protrusions 4, and thereby transferring the uncured light absorbing material 8 to the protrusions 4 to produce a lenticular lens sheet 2 including a layer 9 consisting of a light absorbing material on the tops of the protrusions 4 and at least a part of the slopes of the protrusions 4, characterized in that the direction of relative movement of the lenticular lens sheet substrate 10 with respect to the axis of the print roll is generally perpendicular to the axis of the print roll, and generally parallel with the direction of the length of the lenticular lens, and the direction of rotation of the print roll and the direction of movement of the lenticular lens sheet substrate with respect to the axis of the print roll are equal to each other, and the linear speed of the print roll outer periphery differs from the moving speed of the lenticular lens sheet substrate with respect to the axis of the print roll by a speed difference of within ±5%.

### TECHNICAL FIELD

The present invention relates to a lenticular lens sheet for use in a rear projection type television, or the like, and a production method thereof. The present invention provides a method for stably producing a lenticular lens sheet which includes a layer consisting of a light absorbing material provided also at least a part of the side of each protrusion of a lenticular lens sheet substrate, absorbs an external light with more effect, and provides an improved contrast.

### BACKGROUND ART

A schematic diagram of a configuration of a transmission type screen conventionally and generally used in a rear projection type television is shown in FIG. 2. In FIG. 2, 1 denotes a Fresnel lens sheet, and 2 denotes a lenticular lens sheet. In general, the Fresnel lens sheet 1 and the lenticular lens sheet 2 are in contact with each other to constitute a transmission type screen. Generally, a Fresnel lens sheet is composed of a sheet provided with a Fresnel lens made up of evenly spaced and concentric fine pitch lenses on the light emitting surface.

In the lenticular lens sheet 2, semi-cylindrical lenses are arranged on the light entering surface side so as to be evenly spaced from one another. The light emitted from the Fresnel lens sheet is largely diffused along the horizontal direction by the lenticular lens sheet 2. This enables the observation of an image within a wide region of visual field along the horizontal direction. A material including a diffusion agent dispersed therein is generally used for the lenticular lens sheet 2 in order to extend the region in which an image is observable not only along the horizontal direction but also along the vertical direction. Further, for a lenticular lens sheet used in combination with a 3-tube type CRT light source, the condensing portions of the respective lenses provided on the light entering surface side may be formed in convex lens shapes particularly in order to correct the color unevenness among three colors.

In such a lenticular lens sheet, as shown in FIG. 7, protrusions 4 are formed at the sites except for the condensing portions 3 of the respective lenses 11 provided on the light entering surface side. The tops of the protrusions 4 are provided thereon with a layer 9 consisting of a light absorbing material such as black ink. Thus, the contrast in a bright room has been improved.

However, only the provision of the light absorbing material layer on the top of each protrusion of the lenticular lens sheet cannot be said to be sufficient in order to obtain a high image contrast under an environment in which an external light is present. As a result, it becomes a problem to still more reduce the reflection of an external light.

Under such circumstances, it has been proposed that an external light absorbing material layer is provided on the top and the side of each protrusion of a lenticular lens sheet (see, JP-A No. 59-87042). This method enables an increase in external light absorbing area, which enables an increase in the proportion of an external light to be absorbed. However, even if an attempt has been made to form an external light absorbing material layer on the whole of the tops and the sides of the lenticular lenses by a conventional external light absorbing material layer forming means such as screen printing, it has been difficult to form the external light absorbing material layer on the protrusion sides without depositing the external light absorbing material on the lens portions.

Whereas, JP-A No. 8-190150 discloses a method in which a light absorbing material layer is provided on the slopes of each protrusion using a print roll. However, with this method, the light absorbing material layer can be formed only one side of the two slopes per single printing. Accordingly, provision of the layer on the slopes on the opposite sides requires double printing steps. Further, the axis of the print roll is parallel with the direction of the length of the lenticular lens. For this reason, unfavorably, it has been virtually difficult to perform printing immediately after extrusion on the lenticular lens sheet manufactured by an extrusion process, and other problems have occurred.

The present invention has been made in order to solve such problems. It is an object thereof to provide a method for efficiently producing a lenticular lens sheet offering excellent contrast.

### DISCLOSURE OF THE INVENTION

The foregoing object is achieved by a method for producing a lenticular lens sheet, which comprises a step of, on a lenticular lens sheet substrate having a lens group made up of lenticular lenses arranged in parallel to one another on one side of the light transmissive substrate, and protrusions each made up of a top and slopes at non-condensing portions of the lenticular lenses on the other side, rotating a print roll coated with an uncured light absorbing material, relatively moving the lenticular lens sheet substrate and the axis of the print roll while bringing the print roll in contact with the tops of the protrusions, and thereby transferring the uncured light absorbing material to the protrusions to produce a lenticular lens sheet including a layer consisting of the light absorbing material on the tops of the protrusions and at least a part of the slopes of the protrusions, characterized in that the direction of movement of the lenticular lens sheet substrate with respect to the axis of the print roll is generally perpendicular to the axis of the print roll, and generally parallel with the direction of the length of the lenticular lens, and the direction of rotation of the print roll and the direction of movement of the lenticular lens sheet substrate with respect to the axis of the print roll are equal to each other, and the linear speed of the print roll outer periphery differs from the moving speed of the lenticular lens sheet substrate with respect to the axis of the print roll by a speed difference of within ±5%.

Further, the object of the present invention is also achieved by a production method characterized by including a step of curing the light absorbing material after an elapse of a time period during which the uncured light absorbing material runs along the slopes of the protrusions by the self-weight and/or a compulsive force after coating of the uncured light absorbing material on the protrusions.

Still further, the object of the present invention is also achieved by a production method in which a layer consisting of a light absorbing material is provided on the slopes of the protrusions by any of the foregoing methods, characterized in that the condensing portion of each lenticular lens is a convex cylindrical lens, and characterized by including a step of, on the lenticular lens sheet substrate having concave parts in the boundary areas each between the condensing portion and the protrusion of the lenticular lens, filling the uncured light absorbing material in the boundary areas, and a step of removing the uncured light absorbing material deposited on the areas except for the boundary areas.

### BRIEF DESCRIPTION OF THE DRAWINGS

FIG. 1 is a schematic cross sectional diagram of a lenticular lens sheet of the present invention; FIG. 2 is a schematic diagram of a configuration of one example of a transmission type screen to be used for a rear projection type television; FIG. 3 is a schematic cross sectional diagram of a lenticular lens sheet substrate for use in the present invention; FIG. 4 is a diagram (top view) illustrating one example of a method for producing the lenticular lens sheet in accordance with the present invention; FIG. 5 is a diagram (side view) illustrating one examples of a method for producing the lenticular lens sheet in accordance with the present invention; FIG. 6 is a schematic cross sectional diagram of the lenticular lens sheet in accordance with the present invention; and FIG. 7 is a schematic cross sectional diagram of a lenticular lens sheet in accordance with the related art.

### BEST MODE FOR CARRYING OUT THE INVENTION

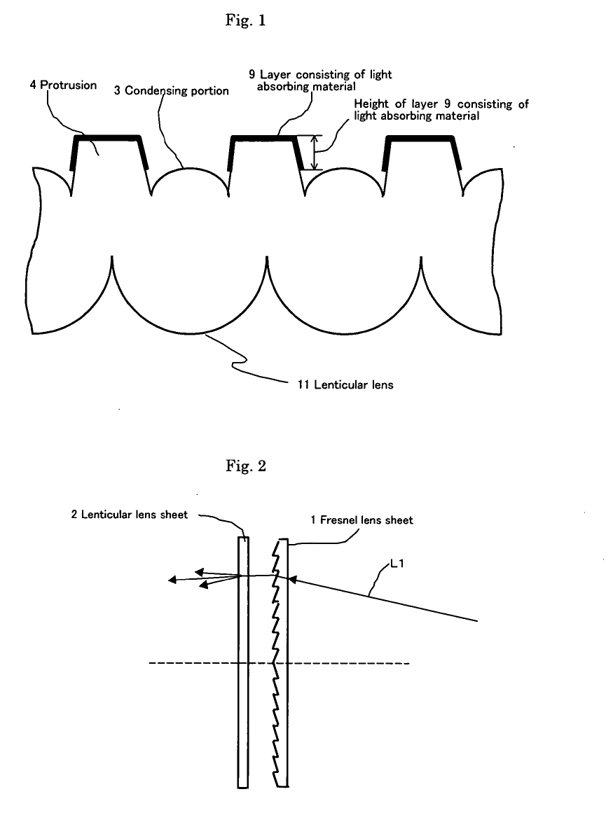

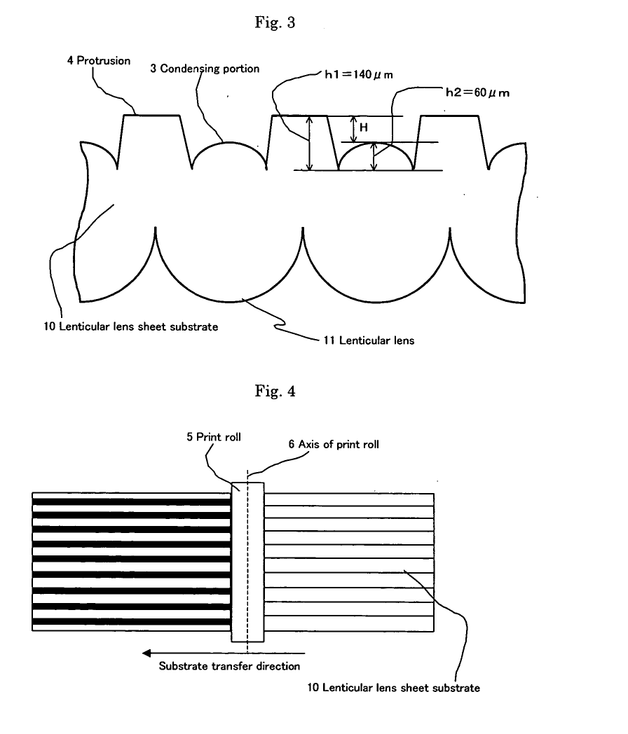

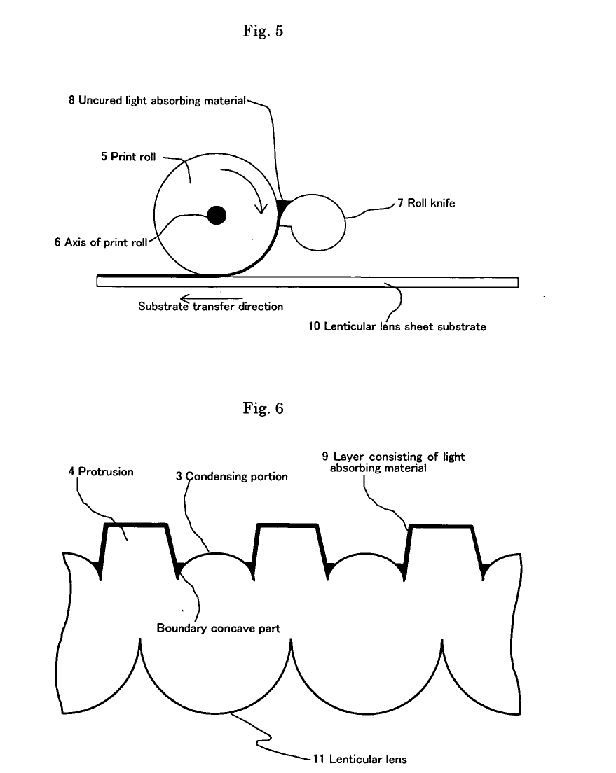

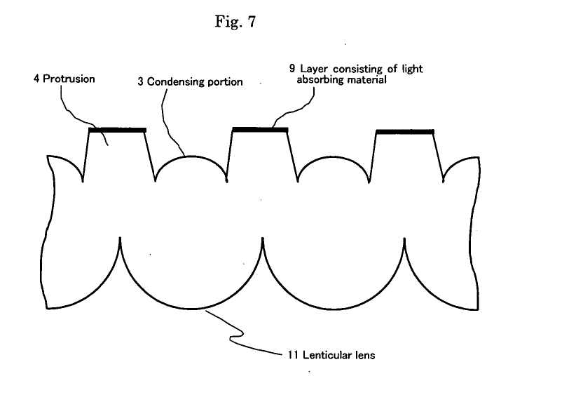

A lenticular lens sheet 2 in the present invention can be produced in the following manner. As shown in FIG. 1, a lenticular lens sheet substrate 10 having a lens group made up of lenticular lenses 11 arranged in parallel to one another on one side of the light-transmissive substrate, and having protrusions 4 each made up of slopes and a top at non condensing portions of the lenticular lenses 11 on the other side thereof, is provided with a layer 9 consisting of a light absorbing material on the tops and the slopes of the protrusions 4 with a method described later.

The present invention provides the following production method. As shown in FIGS. 4 and 5, the surface of a print roll 5 is coated with an uncured light absorbing material 8. While rotating the roll coated with the uncured light absorbing material 8, and bringing it in contact with the tops of the protrusions 4 of the lenticular lens sheet substrate 10, the lenticular lens sheet substrate 10 and the axis 6 of the print roll are moved relatively to each other. This allows the uncured light absorbing material 8 which has come in contact with the tops of the protrusions 4 to run over the slopes of the protrusions 4, and then to be cured. As a result, the layer 9 consisting of a light absorbing material is provided on a part of, or on the whole of the slopes. Therefore, the lenticular lens sheet 2 obtainable according to the present invention is capable of inhibiting the reflection of an external light, and increasing the contrast.

Further, the present invention has the following advantages. The direction of the relative movement of the axis 6 of the print roll and the lenticular lens sheet substrate 10 is generally perpendicular to the axis 6 of the print roll, and generally parallel with the direction of the length of the lenticular lenses 11. Accordingly, it is possible to uniformly coat the uncured light absorbing material 8 on the slopes on the opposite sides of the protrusions 4. Further, it is easy to provide the layer 9 consisting of a light absorbing material immediately after production of the lenticular lens sheet substrate 10 by an extrusion process described later.

Incidentally, in the present invention, the operation of relatively moving the axis 6 of the print roll and the lenticular lens sheet substrate 10 denotes: the following acceptable operation of moving the axis 6 of the print roll, moving the lenticular lens sheet substrate 10, or moving both of them, with reference to the floor surface.

In the present invention, when the uncured light absorbing material 8 coated on the print roll 5 comes in contact with the protrusions of the non condensing portions of the lenticular lens sheet substrate 10, a part of the uncured light absorbing material 8 overflows from the tops of the protrusions. This enables the uncured light absorbing material 8 to be coated over the wide region of the slopes of the protrusions 4. The direction of rotation of the print roll 5 is equal to the direction of movement of the lenticular lens sheet substrate 10 with respect to the axis 6 of the print roll; and the linear speed of the outer periphery of the print roll 5 and the speed of movement of the lenticular lens sheet substrate 10 with respect to the axis 6 of the print roll are required to differ from each other by a speed difference of within 15%, and preferably equal to each other. Herein, in the case where the direction of rotation of the print roll 5 and the direction of movement of the lenticular lens sheet substrate 10 with respect to the axis 6 of the print roll are opposite to each other, unfavorably, it becomes difficult to uniformly coat the light absorbing material on the opposite-side slopes of the protrusions, and the coating heights of the protrusion slopes become not uniform unless the print roll axis and the direction of the length of the stripe-like protrusions are precisely perpendicular to each other. In the case where the direction of rotation of the print roll 5 and the direction of movement of the lenticular lens sheet substrate 10 with respect to the axis 6 of the print roll are equal to each other, but the linear speed of the outer periphery of the print roll 5 is larger or smaller than the speed of movement of the lenticular lens sheet substrate 10 with respect to the axis 6 of the print roll, in either case, unfavorably, the uncured light absorbing material tends to be deposited on the condensing portions, and defects tend to occur.

Whereas, during the period after coating of the uncured light absorbing material 8 on the tops of the protrusions 4 of the lenticular lens sheet substrate 10 until curing thereof, the uncured light absorbing material 8 extends over a wider region of the slopes of the protrusions 4 by the self-weight of the uncured light absorbing material 8 and the surface tension. Utilizing this phenomenon, it is possible to provide the layer 9 consisting of a light absorbing material over a still wider region of the slopes of the lenticular protrusions 4. At this step, promotion of running of the uncured light absorbing material 8 by a method such as air blowing or use of centrifugal force is effective.

At this step, the height of the layer 9 consisting of a light absorbing material provided on the slopes of the protrusions 4 is preferably not less than the recess height H defined according to the following equation (1) in terms of the contrast of the lenticular lens sheet 2:

H=h1−h2 (1)

(where h1 denotes the height from the lowest portion of the boundary area between the lenticular lens condensing portion 3 and protrusion 4 to the highest portion of the protrusion 4, and h2 denotes the height from the lowest portion of the boundary area between the lenticular lens condensing portion 3 and protrusion 4 to the highest portion of the condensing portion 3 of the lenticular lens sheet.)

Whereas, the thickness of the uncured light absorbing material 8 coated on the print roll 5 is preferably not more than the recess height H in terms of stably coating the uncured light absorbing material 8. When the uncured light absorbing material 8 coated on the print roll 5 is increased in thickness, outward appearance defects such as deposition of an ink also on the condensing portions tend to occur.

The inclination of the slopes of the protrusions 4 of the lenticular lens sheet 2 in the present invention preferably falls within a range of 20° to 90° relative to the lenticular lens sheet substrate 10. When the inclination of the slopes is smaller than 20° or larger than 90°, the uncured light absorbing material 8 may not extend sufficiently over the slopes, which results in a decrease in region to be printed.

In accordance with another embodiment of the present invention, the condensing portion 3 of the lenticular lens 11 is a convex cylindrical lens, and a concave part is present at the boundary area between the condensing portion 3 and the protrusion 4 which is a non condensing portion of the lenticular lens 11. In such a case, before and after provision of the layer 9 consisting of a light absorbing material on the slopes of the protrusions 4 with the foregoing method, on the lenticular lens sheet substrate 10, an uncured light absorbing material 8 is filled in the boundary areas, and the uncured light absorbing material 8 deposited on the areas except for the boundary areas is removed, and cured. As a result, it is possible to obtain a lenticular lens sheet 2 (see, FIG. 6) provided with the layer 9 consisting of a light absorbing material on the boundary areas.

The light absorbing materials to be coated on the protrusions 4 of the lenticular lens sheet 2, for use in the present invention, maybe those known in the art. For example, an ink prepared by mixing a pigment and carbon black is usable.

Whereas, the materials usable for the surface of the print roll 5 coated with the uncured light absorbing material 8 in the present invention are various materials including rubber elastic bodies such as synthetic rubber, metals, and the like, and may be appropriately selected according to the physical properties of the light absorbing material to be used.

Further, for feeding the uncured light absorbing material 8 to the print roll 5 in the present invention, the methods known in the prior art are adoptable. For example, a doctor blade method, a gravure roll method, a die coat method, a roll knife method, and the like are usable. Use of roll knife is preferred in terms of the ease of equalization of the coating thicknesses along the direction of the width of the light absorbing material.

It is possible to produce the lenticular lens sheet substrate 10 in the present invention by various methods. Examples thereof may include an extrusion method and a hot press method. Out of these, an extrusion method is preferred in terms of the homogeneity of the product performances, and the like.

### EXAMPLE 1

In this example, as a lenticular lens sheet substrate 10, the extruded one having the cross sectional shape as shown in FIG. 3 was used. On the light emitting side thereof, a convex cylindrical lens and a protrusion 4 as an external light absorbing part were formed on each condensing portion 3 and each non condensing portion of the lenticular lens 11, respectively. The height h2 of the convex cylindrical lens of the condensing portion 3 was 60 μm, and the height h1 of the protrusion 4 was 140 μm.

As shown in FIG. 5, a print roll 5 is a chrome-plated metal roll, and disposed in such a manner that the clearance from a roll knife 7 is adjustable from about 5 μm to 100 μm. A black ink (uncured light absorbing material 8) to be coated is filled between the print roll 5 and the roll knife 7, so that the rotation of the print roll 5 causes the uncured ink to be deposited on the surface.

By the use of “VAR ink” manufactured by Teikoku Printing Inks Mfg., Co., Ltd., as a black ink, printing was performed on the protrusions of the lenticular lens sheet substrate 10. The clearance between the roll knife 7 and the print roll 5 was adjusted at 55 μm, and the print roll 5 was rotated at a linear speed of the outermost periphery of 5 m/min (which caused the ink to be deposited to a thickness of 50 μm on the surface of the print roll 5). Thus, with the lenticular lens sheet substrate 10 in contact with the print roll 5, the lenticular lens sheet substrate 10 was moved at a speed of 5 m/min in the same direction as the direction of rotation of the print roll 5 by means of a lenticular lens sheet substrate transfer device 12 not shown. As a result, the ink was printed on the protrusions 4 of the lenticular lens sheet substrate 10.

The protrusions 4 of the lenticular lens sheet 2 obtained were observed under a microscope. As a result, it was found that not only the tops but also the whole of the sides of the protrusions 4 were printed, and that no ink was deposited on the convex cylindrical lenses at the condensing portions 3.

### EXAMPLE 2

Printing was performed on the lenticular lens sheet substrate 10 in the same manner as in Example 1, except that the height h1 of each protrusion 4 in the lenticular lens sheet substrate 10 was set at 200 μm, and that the clearance between the roll knife 7 and the print roll 5 was adjusted at 80 μm. At this step, an ink was deposited to a thickness of 75 μn on the surface of the print roll 5. The protrusions 4 of the lenticular lens sheet 2 obtained were observed under a microscope. As a result, it was found that not only the tops but also the whole of the sides of the protrusions 4 were printed, and that no ink was deposited on the convex cylindrical lenses at the condensing portions 3.

### Comparative Example 1

Printing was performed on the lenticular lens sheet substrate 10 in the same manner as in Example 1, except that the lenticular lens sheet substrate 10 was moved in the same direction as the direction of rotation of the print roll 5 at a speed of 4.7 m/min. The protrusions 4 of the lenticular lens sheet 2 obtained were observed under a microscope. As a result, it was found that the ink was deposited on the convex cylindrical lenses of the condensing portions 3, and further resulted in extended streaks along the direction of movement of the substrate.

### Comparative Example 2

Printing was performed on the lenticular lens sheet substrate 10 in the same manner as in Example 1, except that the lenticular lens sheet substrate 10 was moved in the opposite direction to the direction of rotation of the print roll 5 at a speed of 5.0 m/min. The protrusions 4 of the lenticular lens sheet 2 obtained were observed under a microscope. As a result, it was found that the slope coating heights were not uniform, and that nonuniformity was apparently observable.

### Comparative Example 3

By the use of “POS black ink” manufactured by Teikoku Printing Inks Mfg., Co., Ltd., as a black ink, printing was performed on the protrusions of the same lenticular lens sheet substrate 10 as that used in Example 1 by screen printing. As a screen gauze, “TETORON SCREEN” (305 lines/inch) manufactured by NBC Industry Co., Ltd., was used, a squeegee with a rubber hardness of 55 to 60 degrees was used, and the printing squeegee pressure was set at 1.0 kg/cm². Thus, printing was performed on the lenticular lens sheet substrate 10. As a result, the ink was printed only on the tops of the protrusions of the lenticular lens sheet substrate 10, and it was not possible to coat the ink on the sides. Further, no ink was deposited on the convex cylindrical lenses at the condensing portions 3.

### Comparative Example 4

Printing was performed in the same manner as in Comparative Example 1, except that printing was performed on the lenticular lens sheet substrate 10 at a printing squeegee pressure of 1.2 kg/cm². As a result, the ink was printed on the tops and to a height of 30 μm of the slopes of the lenticular lens sheet substrate 10. However, the ink was deposited on the convex cylindrical lenses at the condensing portions 3, so that the outward appearance was very poor.

### EXAMPLE 3

In order to evaluate the lenticular lens sheets obtained in accordance with Examples 1 and 2, and Comparative Example 3, the respective lenticular lens sheets were each combined with the same Fresnel lens to be mounted on a projection television (KP-E53 MH11, manufactured by Sony corporation), and evaluated for the reflection intensity of an external light by ten observers selected at random. As a result, all of the ten observers judged that each lenticular lens sheet of Examples 1 and 2 has lower reflection intensity of an external light and deeper black as compared with the lenticular lens sheet of Comparative Example 3.

### INDUSTRIAL APPLICABILITY

The present invention provides a method for stably producing a lenticular lens sheet which includes a layer consisting of a light absorbing material provided also at least a part of the sides of a protrusion of a lenticular lens sheet substrate, and absorbs an external light with more effect, and provides an improved contrast.

1. A method for producing a lenticular lens sheet, comprising a step of, on a lenticular lens sheet substrate having a lens group made up of lenticular lenses arranged in parallel to one another on one side of the light transmissive substrate, and protrusions each made up of a top and slopes at non-condensing portions of the lenticular lenses on the other side, rotating a print roll coated with an uncured light absorbing material, relatively moving the lenticular lens sheet substrate and the axis of the print roll while bringing the print roll in contact with the tops of the protrusions, and thereby transferring the uncured light absorbing material to the protrusions to produce a lenticular lens sheet including a layer consisting of a light absorbing material on the tops of the protrusions and at least a part of the slopes of the protrusions, characterized in that the direction of movement of the lenticular lens sheet substrate with respect to the axis of the print roll is generally perpendicular to the axis of the print roll, and generally parallel with the direction of the length of the lenticular lens, and the direction of rotation of the print roll and the direction of movement of the lenticular lens sheet substrate with respect to the axis of the print roll are equal to each other, and the linear speed of the print roll outer periphery differs from the moving speed of the lenticular lens sheet substrate with respect to the axis of the print roll by a speed difference of within ±5%.

2. The method for producing a lenticular lens sheet according to claim 1, characterized by including a step of curing the light absorbing material after an elapse of a time period during which the uncured light absorbing material runs along the slopes of the protrusions by the self-weight and/or a compulsive force after coating of the uncured light absorbing material on the protrusions.

3. The method for producing a lenticular lens sheet according to claim 1 or 2, characterized in that the height of the layer consisting of the light absorbing material provided on the slopes of the protrusions is not less than the recess height H defined according to the following equation (1):
H=h1−h2 (1)
(where h1 denotes the height from the lowest portion of the boundary area between the lenticular lens condensing portion and protrusion to the highest portion of the protrusion, and h2 denotes the height from the lowest portion of the boundary area between the lenticular lens condensing portion and protrusion to the highest portion of the condensing portion of the lenticular lens.)

4. The method for producing a lenticular lens sheet according to claim 3, characterized in that the thickness of the uncured light absorbing material to be coated on the print roll is less than the recess height H defined according to the foregoing equation (1).

5. The method for producing a lenticular lens sheet according to any of claims 1 to 4, characterized in that the condensing portion of each lenticular lens is a convex cylindrical lens, and characterized by including a step of, on the lenticular lens sheet substrate having concave parts in the boundary areas each between the condensing portion and the protrusion of the lenticular lens, filling the uncured light absorbing material in the boundary area, and a step of removing the uncured light absorbing material deposited on the areas except for the boundary areas.
